(19) United States
(12) Patent Application Publication
(10) Pub. No.: US 2026/0321150 A1
(43) Pub. Date: Oct. 15, 2026

(54) METHOD OF USING FINGER WEARABLE ITEMS FOR PROMOTING LEARNING OF MATH AND SPELLING BY CHILDREN

(71) Applicant: Kevin McIntosh, Traverse City, MI (US)

(72) Inventor: Kevin McIntosh, Traverse City, MI (US)

(21) Appl. No.: 19/303,669

(22) Filed: Aug. 19, 2025

Related U.S. Application Data
(63) Continuation-in-part of application No. 18/734,173, filed on Jun. 5, 2024, now abandoned.
(60) Provisional application No. 63/522,749, filed on Jun. 23, 2023.

(51) Int. Cl. G09B 1/32; A44C 9/00

(52) U.S. Cl. CPC G09B 1/32; A44C 9/0053

(57) ABSTRACT

A method of using finger wearable items for promoting use with numbers, letters and symbols for providing a visual aid to learning, including the steps of providing a kit containing a plurality of sleeve shaped flexible sleeve shaped bodies adapted to being worn over a metacarpal bone of the user's fingers and/or thumbs. An indicia scheme is incorporating into an exterior of the sleeve shaped bodies and including a first scheme of mathematical numbers and symbols exhibited on first sub-plurality of the bodies, and a second scheme of letters and punctuation symbols exhibited on a second sub-plurality of the bodies. The user alternatively wears selected sub-pluralities of the bodies for providing an entertaining visual tool to assist with learning.

### CROSS REFERENCE TO RELATED APPLICATIONS

The present application is a continuation in part of and claims priority from U.S. Ser. No. 18/734,173 filed Jun. 5, 2024. The '173 application claims priority of U.S. Ser. No. 63/522,749 filed Jun. 23, 2023.

### FIELD OF THE INVENTION

The present invention relates generally to educational and instructional materials for use by children. More specifically, the present invention teaches a kit assembly and method using finger wearable items for promoting learning of math and spelling through use with numbers, letter and symbols.

### BACKGROUND OF THE INVENTION

Various types of finger attachments or devices are known in the art for varying applications. A first example of this is set forth in U.S. Pat. No. 5,577,272 to Fisher which teaches a finger sleeve constructed of an elastomeric material.

Wanzenried U.S. Pat. No. 6,243,868 teaches a sleeve shaped fingertip protector with a flexible strip. An adhesive backing on the inner surface of the strip includes a release liner which, upon removal, secures the protector to the finger.

Lavner, US 2008/0005822, teaches a finger wearable sleeve having an indicia revealing outer surface which can include any text or graphic (sports team name, logo or the like).

US 2021/0298397, to Ramirez, teaches a plurality of finger sleeves including reusable grip enhancing tubular members for increased performance in hand and arm task activities.

Other finger wearable items for providing learning or instruction are also know and include the system for teaching mathematics in Hancock, U.S. Pat. No. 6,155,836 which includes a series of gloves and/or finger puppets with the digits representing non-sequential number series.

Cubeta U.S. Pat. No. 6,951,464 teaches a reading learning tool using finger puppets having letters thereon as well as pictures of objects corresponding to the sound of the letter, such that the finger puppets can be worn by a student and arranged to correspond to a word.

### SUMMARY OF THE INVENTION

The present invention discloses a kit assembly and method of using finger wearable items for promoting use with numbers, letter and symbols. The kit includes a plurality of flexible sleeve shaped bodies adapted to being worn over the user's fingers and/or thumbs. Each of the flexible bodies further including a surface indicia including at least one of numbers, letters, color or symbols, such that arrangement of the bodies providing a visual tool to assist with child learning in an entertaining fashion.

The corresponding method of using finger wearable items for promoting use with numbers, letters and symbols includes the steps of providing a kit containing a plurality of sleeve shaped flexible sleeve shaped bodies adapted to being worn over a metacarpal bone of the user's fingers and/or thumbs and incorporating an indicia scheme into an exterior of said sleeve shaped bodies. The indicia scheme includes a first scheme of mathematical numbers and symbols exhibited on first sub-plurality of the bodies, along with a second scheme of letters and punctuation symbols exhibited on a second sub-plurality of the bodies.

The method further includes the user alternatively wearing selected sub-pluralities of the bodies for providing an entertaining visual tool to assist with learning. The step of providing the first scheme of mathematical symbols further includes providing addition, subtraction, multiplication and division signals. In a further application, the bodies can be adapted to being arranged upon a surface in order to provide additional non-worn arrangements and representations.

The step of providing each of the bodies as a flexible and elastomeric body includes without limitation Spandex®. The first scheme of mathematical symbols further includes providing addition, subtraction, multiplication and division signals.

### BRIEF DESCRIPTION OF THE DRAWINGS

Reference will now be made to the attached drawings, when read in combination with the following detailed description, wherein like reference numerals refer to like parts throughout the several views, and in which:

FIG. 1A is a schematic illustration of the kit assembly with finger wearable items such as for use by children and in order to promote educational and hand motor skills, such as which can be provided according to different color, sizes, patterns and the like and, in the given illustration, providing a collection of wearable mathematical equation representations;

FIG. 1B is an enlarged view of a selected finger wearable item according to the present invention;

FIG. 1C provides a further schematic illustration of a collection of finger wearable items in a crossword puzzle arrangement according to a further variant of the present invention;

FIG. 2 illustrates an assortment of finger and thumb wearable articles according to additional non-limiting examples of the present invention; and

FIG. 3 is an environmental view depicting a selection of the wearable articles positioned on the user's fingers and thumbs.

### DETAILED DESCRIPTION OF THE PREFERRED EMBODIMENTS

With reference to the attached illustrations, the present invention discloses a kit assembly and method using finger wearable items for promoting use with numbers, letter and symbols. As will be further described, the finger wearable items are for use, such as by children in an entertaining fashion in order to promote educational and hand motor skills, such as which can be provided according to different color, sizes, patterns and the like.

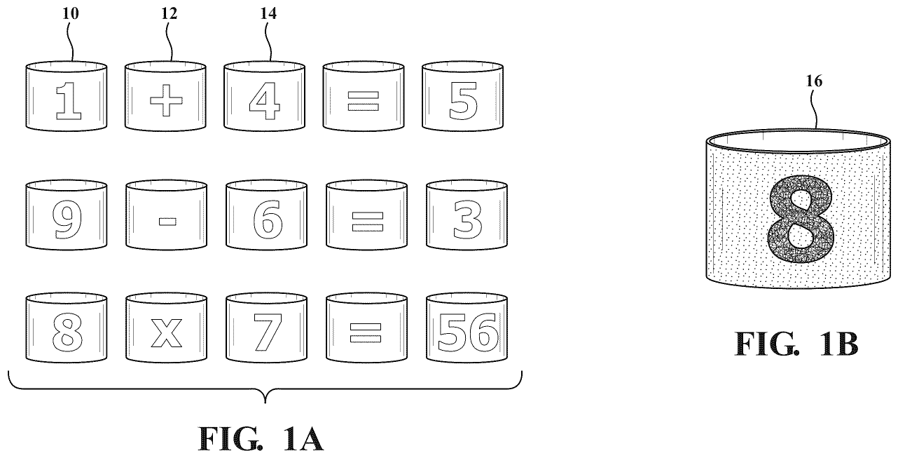

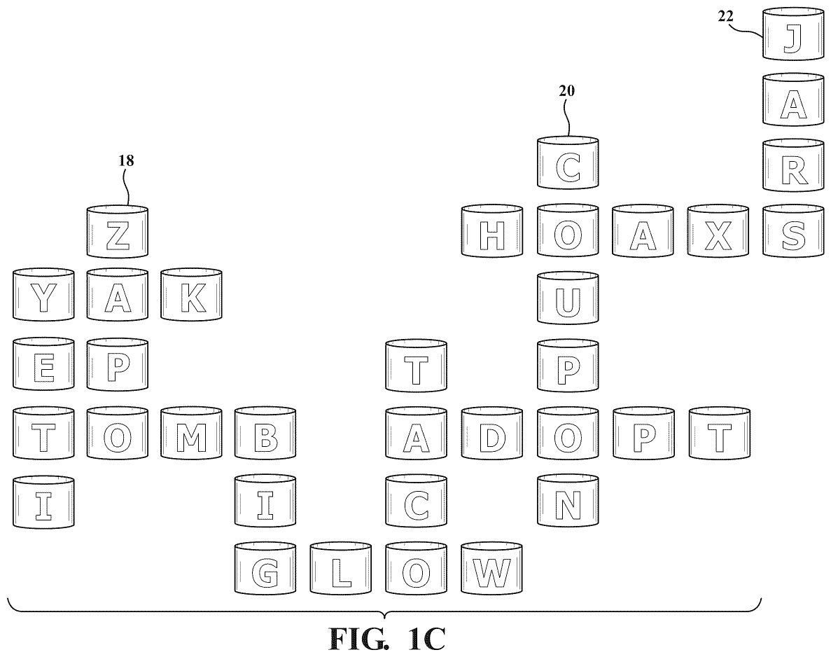

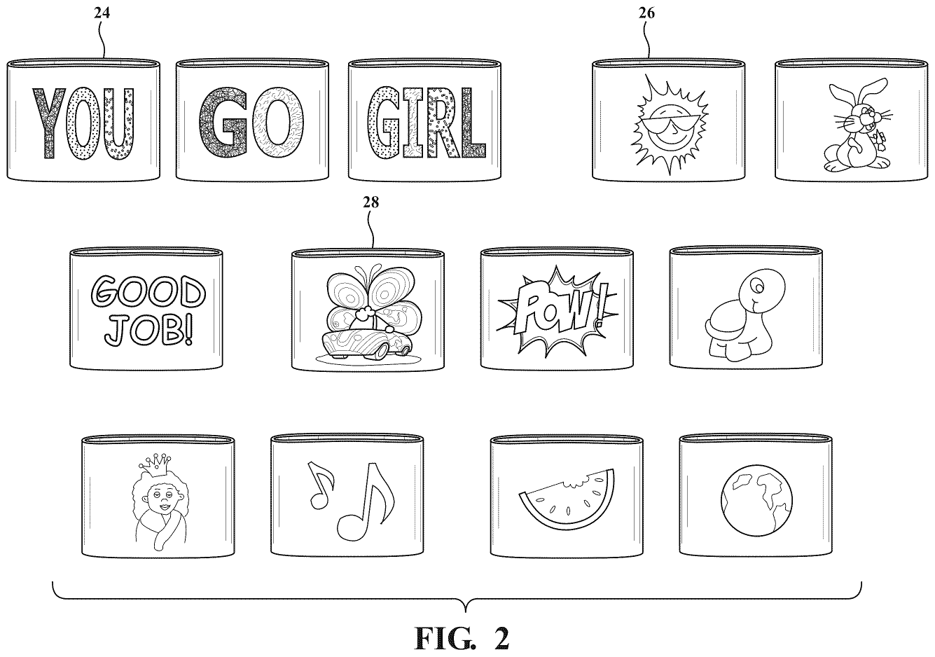

Referring to each of FIGS. 1A, 1B and 1C, a series of schematic illustrations are shown which are representative of a plurality of finger and thumb wearable attachments according to a non-limiting embodiment of the present invention.

In the instance of FIG. 1A, a collection of wearable attachments exhibiting mathematical representations, arranged in equation form, are depicted at 10, 12, 14, et seq., such providing numerical representations “1-9”, “+”, “×”, “=”. Without limitation, the present invention teaches a plurality of flexible sleeve shaped bodies, see as shown in individual representation at 16 in FIG. 1B, and such as constructed from a Spandex® or any similar elastomeric material, which exhibit a desired indicia and can be worn by the user in order to provide a visual device to assist in developing basic motor skills along with hand and eye coordination. The flexible bodies are sized so that they can be comfortably worn and which are adaptable to varying sized fingers of children and adolescents and which, in use, provide an element of fun to the educational process.

As is generally known, children learn to count with their fingers and, in view of this, the present kit and assembly provides an effective visual for promoting development of these basic motor skills. As previously noted in FIG. 1A, the flexible material bodies shown can include any combination of numbers (e.g. as shown by numbered bodies at 1, 4, 5, 9, 6, 3, 8, 7 and 56), letters (a subset of which depicted by bodies at Z, Y, A, K, E, etc.), shapes and mathematical symbols (see as represented by bodies depicting “+” and “=”). As is further depicted, the flexible bodies can be provided in any variation of size, shape and color, such that they are suitably worn in varied subset combinations in order to utilize the child's finger counting tendencies and to assist in developing various learning skills not limited to rote or repetitive use of the flexible bodies for developing proficiency in mathematics, spelling, language and the like.

Another non-limiting example of an arrangement of finger and thumb wearable attachments shown in FIG. 1C depict a crossword puzzle kit assembly in which individual sub-pluralities of the flexible bodies (also generically termed as elastomeric and finger attachable skins) are provided with individual letters, see at 18, 20, 22, et seq., which can be provided for varied skill set training in word forming. As understood, the sleeve shaped attachments need not be worn by the user in every application and can be arranged flat upon a tabletop surface in forming words, as well as any of mathematical equations, other spelling exercises, color identification, and the like.

FIG. 2 illustrates an assortment of finger and thumb wearable articles, see at 24, 26, 28, et seq., according to non-limiting examples of the present invention and which can include an arrangement of symbols which are primarily entertaining in nature. As understood, a kit of finger and thumb wearable items can be provided with a large selection of educational items including the mathematical representations of FIG. 1A, the word representations of FIG. 1C, and the entertaining symbol representations of FIG. 2. In this fashion, the user (including younger children) can employ the wearable items in varying representations in both educational and entertaining arrangements.

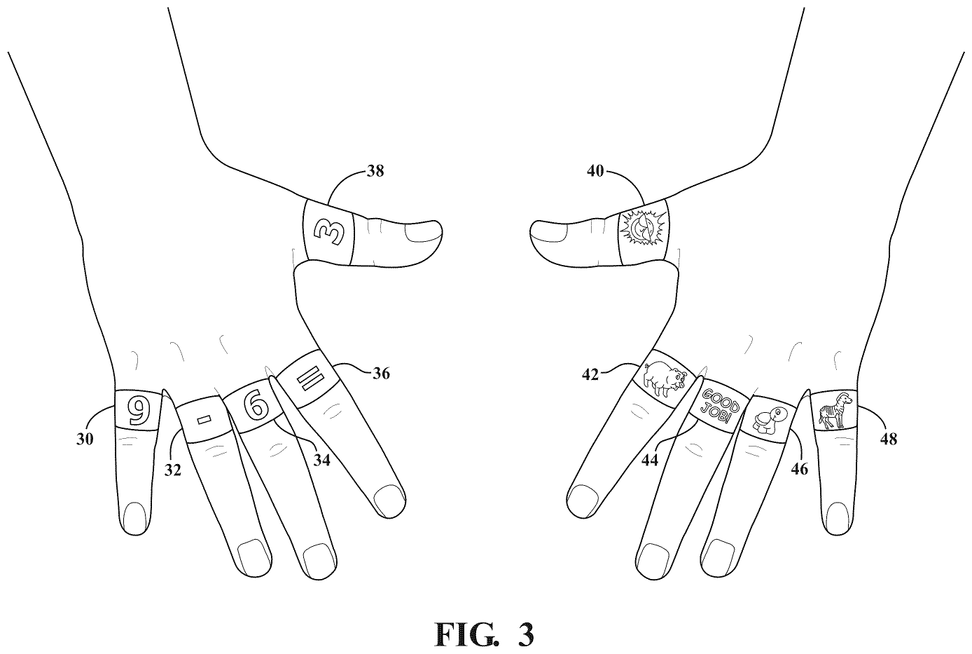

FIG. 3 provides an environmental view depicting a selection of the wearable articles, see as representatively shown at positioned on the user's fingers and thumbs. This includes right hand items (finger 30, 32, 34, 36 and thumb 38) and left hand items (thumb 40 and fingers 42, 44, 46 and 48). As again shown, the wearable articles can be provided with any design or indicia scheme, again not limited to any of letters, numbers, symbols or the like.

Without limitation, the construction and indicia bearing content of the finger skin bodies can be modified from that shown in order to provide different training applications. This can include use such as in a classroom setting and which provide an element of fun associated with the educational process and which provides the child with a game playing exercise while learning.

The corresponding method of using finger wearable items for promoting use with numbers, letters and symbols includes the steps of providing a kit containing a plurality of sleeve shaped flexible sleeve shaped bodies adapted to being worn over a metacarpal bone of the user's fingers and/or thumbs and incorporating an indicia scheme into an exterior of said sleeve shaped bodies. The indicia scheme includes a first scheme of mathematical numbers and symbols exhibited on first sub-plurality of the bodies, along with a second scheme of letters and punctuation symbols exhibited on a second sub-plurality of the bodies.

The method further includes the user alternatively wearing selected sub-pluralities of the bodies for providing an entertaining visual tool to assist with learning. The step of providing the first scheme of mathematical symbols further includes providing addition, subtraction, multiplication and division signals. In a further application, the bodies can be adapted to being arranged upon a surface in order to provide additional non-worn arrangements and representations.

The step of providing each of the bodies as a flexible and elastomeric body includes without limitation Spandex®. The first scheme of mathematical symbols further includes providing addition, subtraction, multiplication and division signals.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A method of using finger wearable items for promoting use with numbers, letters and symbols for providing a visual aid to learning, said method comprising the steps of:
providing a kit containing a plurality of sleeve shaped flexible sleeve shaped bodies adapted to being worn over a metacarpal bone of the user's fingers and/or thumbs;
incorporating an indicia scheme into an exterior of the sleeve shaped bodies and including a first scheme of mathematical numbers and symbols exhibited on first sub-plurality of the bodies, and a second scheme of letters and punctuation symbols exhibited on a second sub-plurality of the bodies; and
alternatively wearing selected sub-pluralities of the bodies for providing an entertaining visual tool to assist with learning.

2. The method according to claim 1, further comprising the step of providing each of the bodies as a flexible and elastomeric body including without limitation Spandex®.

3. The method according to claim 1, further comprising the bodies adapted to being arranged upon a surface in order to provide additional non-worn arrangements and representations.

4. The method according to claim 1, said step of providing the first scheme of mathematical symbols further comprising providing addition, subtraction, multiplication and division signals.

5. A method of using finger wearable items for promoting teaching of mathematics, said method comprising the steps of:
providing a kit containing a plurality of sleeve shaped flexible sleeve shaped bodies adapted to being worn over a metacarpal bone of the user's fingers and/or thumbs;
incorporating an indicia scheme into an exterior of the sleeve shaped bodies and including a scheme of mathematical numbers and symbols exhibited on the bodies, the mathematical symbols further including addition, subtraction, multiplication and division signals; and
wearing selected sub-pluralities of the bodies for providing an entertaining visual tool to assist with learning.

6. A method of using finger wearable items for promoting teaching of spelling, said method comprising the steps of:
providing a kit containing a plurality of sleeve shaped flexible sleeve shaped bodies adapted to being worn over a metacarpal bone of the user's fingers and/or thumbs;
incorporating an indicia scheme into an exterior of the sleeve shaped bodies and including a scheme of letters and punctuation symbols exhibited on the bodies; and
wearing selected sub-pluralities of the bodies for providing an entertaining visual tool to assist with learning.
